(19) United States
(12) Patent Application Publication
(10) Pub. No.: US 2026/0186318 A1
(43) Pub. Date: Jul. 2, 2026

(54) DISPLAY DEVICE FOR DISPLAYING THREE DIMENSIONAL IMAGES

(71) Applicant: LG Display Co., Ltd., Seoul (KR)

(72) Inventors: JuSeong PARK, Gimpo-si (KR); JoungWon WOO, Goyang-si (KR); Wook JEON, Daejeon (KR)

(73) Assignee: LG Display Co., Ltd., Seoul (KR)

(21) Appl. No.: 19/353,230

(22) Filed: Oct. 8, 2025

(30) Foreign Application Priority Data
Dec. 30, 2024 (KR) 10-2024-0200915

(51) Int. Cl. G02B 30/30

(52) U.S. Cl. CPC G02B 30/30

(57) ABSTRACT

A display device for displaying three-dimensional images is discussed. The display device can include a display panel having a plurality of sub-pixels configured to emit light of different colors. The display device can further include an optical member having a plurality of color slits configured to selectively transmit light emitted from the plurality of sub-pixels. The plurality of color slits transmit the light of different colors.

### CROSS-REFERENCE TO RELATED APPLICATIONS

This application claims priority to Korean Patent Application No. 10-2024-0200915 filed in the Republic of Korea on December 30, 2024, the entire disclosure of which is hereby expressly incorporated by reference into the present application.

### BACKGROUND

### Field

The present disclosure relates to a display device, and more particularly, to a display device capable of displaying three-dimensional (3D) images.

### Discussion of the Related Art

A three-dimensional image display device displays an image in a three-dimensional manner by utilizing the principle in which a sense of depth is generated when different image signals perceived by both eyes are combined. As the methods for implementing three-dimensional images, techniques such as a stereoscopic technique, a volumetric technique, and a holographic technique are known.

Among these methods, the stereoscopic technique can be divided into glasses-based type and glasses-free type. In a conventional glasses-free three-dimensional image display method, in a structure in which barriers and slits constituting a parallax barrier are disposed in the same direction as the alignment direction of pixels formed on the display panel, the left-eye image and the right-eye image output from the display panel can be transmitted only to positions within a certain range through the slits. Due to such a structure of the parallax barrier, when the field of view (FoV) in which a viewer can perceive a three-dimensional image increases, a problem can arise in that the 3D horizontal resolution can decrease in proportion thereto.

### SUMMARY OF THE DISCLOSURE

An object to be achieved by the present disclosure is to provide a three-dimensional image display device capable of increasing 3D horizontal resolution while securing a field of view (FoV).

Another object to be achieved by the present disclosure is to provide a three-dimensional image display device capable of displaying a three-dimensional image in a glasses-free manner without using a barrier that blocks light of all colors.

Objects of the present disclosure are not limited to the above-mentioned objects, and other objects, which are not mentioned above, can be clearly understood by those skilled in the art from the following descriptions.

According to an aspect of the present disclosure, a three-dimensional image display device includes a display panel including a plurality of sub-pixels that emit light of different colors. The three-dimensional image display device further includes an optical member including a plurality of color slits for selectively transmitting light emitted from the plurality of sub-pixels. The plurality of color slits transmit the light of different colors.

According to another aspect of the present disclosure, a three-dimensional image display device includes a display panel including a plurality of first sub-pixels that emit light of a first color, a plurality of second sub-pixels that emit light of a second color, and a plurality of third sub-pixels that emit light of a third color. The three-dimensional image display device further includes an optical member including a plurality of first color slits for transmitting the light of the first color, a plurality of second color slits for transmitting the light of the second color, and a plurality of third color slits for transmitting the light of the third color. The three-dimensional image display device further includes a transmissive layer disposed between the display panel and the optical member to space the display panel apart from the optical member.

Other detailed matters of the example embodiments of the present disclosure are included in the detailed description and the drawings.

According to aspects of the present disclosure, by displaying a three-dimensional image through an optical member including a plurality of color slits that transmit light of different colors, a wide field of view (FoV) can be secured while improving three-dimensional horizontal resolution.

According to aspects of the present disclosure, by displaying a three-dimensional image through an optical member composed only of a plurality of color slits that transmit light of different colors, a high-resolution three-dimensional image can be displayed without using a barrier that blocks light of all colors.

The effects according to aspects of the present disclosure are not limited to the contents exemplified above, and more various effects are included in the present disclosure.

### BRIEF DESCRIPTION OF THE DRAWINGS

The above and other aspects, features and other advantages of the present disclosure will be more clearly understood from the following detailed description taken in conjunction with the accompanying drawings, in which:

FIG. 1 is a block diagram illustrating the configuration of a three-dimensional image display device according to an example embodiment of the present disclosure;

FIG. 2 is an exploded perspective view schematically illustrating a three-dimensional image display device according to an example embodiment of the present disclosure;

FIG. 3 is a cross-sectional view for explaining an optical member of a three-dimensional image display device according to an example embodiment of the present disclosure;

FIG. 4A is an original image to be displayed through the optical member of a three-dimensional image display device according to an example embodiment of the present disclosure;

FIG. 4B is an example of a transmitted image displayed through the optical member of a three-dimensional image display device according to an example embodiment of the present disclosure;

FIG. 5 is a plan view of an optical member according to a comparative embodiment;

FIG. 6 is an example of a transmitted image displayed through the optical member according to the comparative embodiment for the original image of FIG. 4A;

FIG. 7 is an exploded perspective view schematically illustrating a three-dimensional image display device according to another example embodiment of the present disclosure;

FIG. 8 is a cross-sectional view for explaining an optical member of a three-dimensional image display device according to another example embodiment of the present disclosure;

FIG. 9A is a view for explaining an aperture pitch for a single color through the optical member of a three-dimensional image display device according to an example embodiment of the present disclosure; and

FIG. 9B is a view for explaining an aperture pitch for a single color through the optical member of a three-dimensional image display device according to another example embodiment of the present disclosure.

### DETAILED DESCRIPTION OF THE EMBODIMENTS

Advantages and characteristics of the present disclosure and a method of achieving the advantages and characteristics will be clear by referring to example embodiments described below in detail together with the accompanying drawings. However, the present disclosure is not limited to the example embodiments disclosed herein but will be implemented in various forms. The example embodiments are provided by way of example only so that those skilled in the art can fully understand the disclosures of the present disclosure and the scope of the present disclosure.

The shapes, sizes, ratios, angles, numbers, and the like illustrated in the accompanying drawings for describing the example embodiments of the present disclosure are merely examples, and the present disclosure is not limited thereto. Like reference numerals generally denote like elements throughout the disclosure. Further, in the following description of the present disclosure, a detailed explanation of known related technologies can be omitted to avoid unnecessarily obscuring the subject matter of the present disclosure. The terms such as “including,” “having,” and “consist of” used herein are generally intended to allow other components to be added unless the terms are used with the term “only”. Any references to singular can include plural unless expressly stated otherwise.

Components are interpreted to include an ordinary error range even if not expressly stated.

When the position relation between two parts is described using the terms such as “on”, “above”, “below”, and “next”, one or more parts can be positioned between the two parts unless the terms are used with the term “immediately” or “directly”.

When an element or layer is disposed “on” another element or layer, another layer or another element can be interposed directly on the other element or therebetween.

Although the terms such as “first”, “second”, and the like are used for describing various components, these components are not confined by these terms. These terms are merely used for distinguishing one component from the other components, and may not define order or sequence. Therefore, a first component to be mentioned below can be a second component in a technical concept of the present disclosure.

Like reference numerals generally denote like elements throughout the disclosure. Further, the term “can” fully encompasses all the meanings and coverages of the term “may” and vice versa.

A size and a thickness of each component illustrated in the drawing are illustrated for convenience of description, and the present disclosure is not limited to the size and the thickness of the component illustrated.

In the present disclosure, a “display device” can include a display device which includes a display panel and a driver for driving the display panel, in a narrow sense, such as a liquid crystal module (LCM), an organic light emitting module (OLED module), and a quantum dot (QD) module. Further, the “display device” can further include a set electronic device or a set device (or a set device) which is a complete product or a final product including an LCM, an OLED module, a QD module, etc., such as a notebook computer, a television, or a computer monitor, an automotive display device or equipment display device including another type of vehicle and a mobile electronic device including a smart phone or an electronic pad.

Accordingly, the display device of the present disclosure can include not only a display device itself in a narrow sense such as an LCD, an OLED module, a QD module, etc., but also an applied product or a set device which is a final consumer device including the LCD, the OLED module, the QD module, etc.

Further, in some cases, the LCM, the OLED module, or the QD module which is configured by a display panel and a driver can be represented as “a display device” in a narrow sense and an electronic device as a complete product including the LCM, the OLED module, and the QD module can be represented as a “set device”. For example, the display device in the narrow sense includes a liquid crystal (LCD) display panel, an OLED display panel, or a quantum dot display panel and a source printed circuit board (PCB) which is a controller for driving the display panel. In contrast, the set device can be a concept further including a set PCB which is a set controller which is electrically connected to the source PCB to control the entire set device.

As a display panel used in the example embodiments of the present disclosure, any type of display panel such as a liquid crystal display panel, an organic light emitting diode (OLED) display panel, a quantum dot (QD) display panel, and an electroluminescent display panel can be used. The display panel of the present example embodiments are not limited to a specific display panel in which a bezel is bent with a flexible substrate for the organic light emitting diode (OLED) display panel and a back plate support structure therebelow. Further, a display panel used for the display device according to the example embodiments of the present disclosure are not limited to a shape or a size of the display panel.

For example, when the display panel is an OLED display panel, the display panel can include a plurality of gate lines, data lines, and pixels formed at intersecting areas of the gate lines and/or data lines. Further, the display panel can be configured to include an array including a thin film transistor which is an element to selectively apply a voltage to each pixel, a light emitting diode layer on the array, an encapsulation substrate or an encapsulation layer, and the like disposed on the array so as to cover the light emitting diode layer. The encapsulation layer can protect the thin film transistor, the light emitting diode layer, and the like from external impacts and can suppress the permeation of moisture or oxygen into the light emitting diode layer. Further, a layer formed on the array can include an inorganic light emitting layer, for example, a nano-sized material layer, quantum dots, or the like.

The features of various embodiments of the present disclosure can be partially or entirely adhered to or combined with each other and can be interlocked and operated in technically various ways, and the embodiments can be carried out independently of or in association with each other.

Hereinafter, a display device according to example embodiments of the present disclosure will be described in detail with reference to accompanying drawings. All the components of each display device/apparatus according to all embodiments of the present disclosure are operatively coupled and configured.

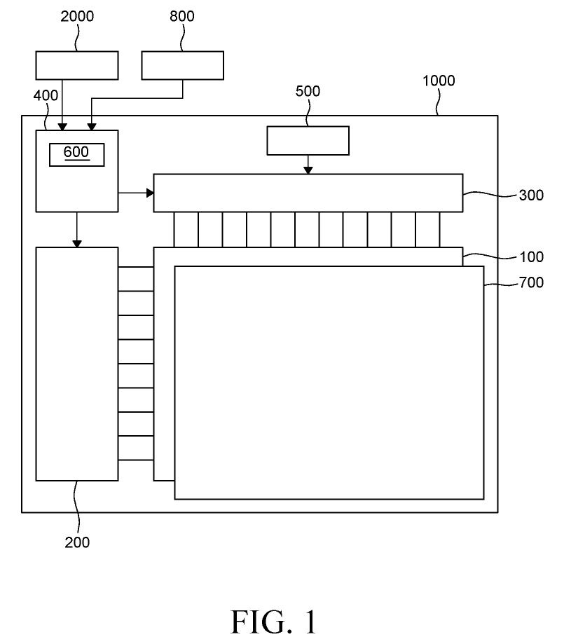

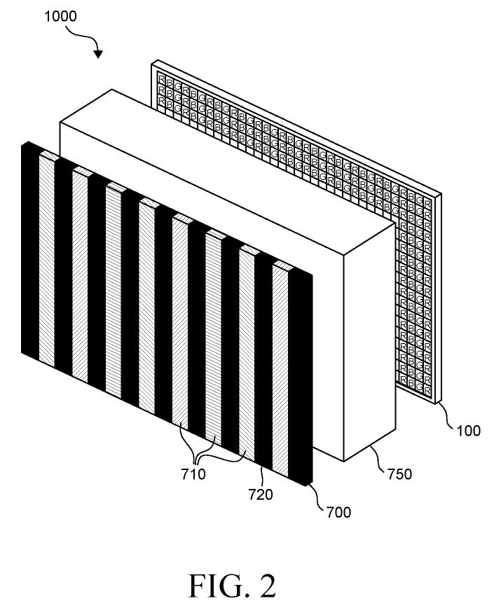

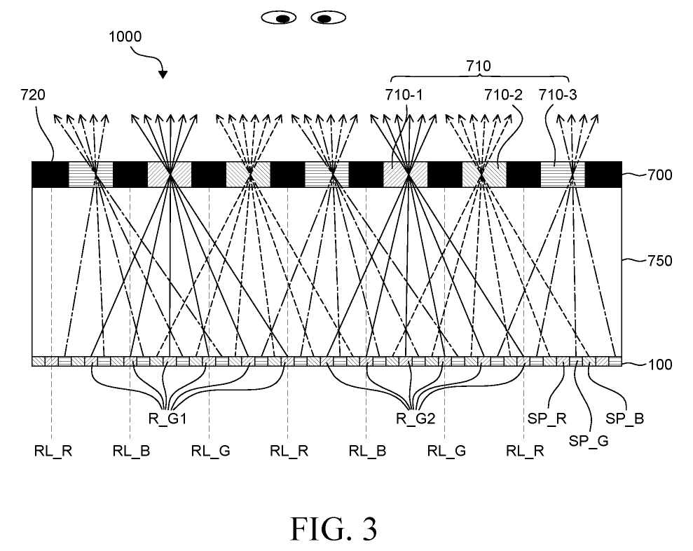

FIG. 1 is a block diagram illustrating the configuration of a three-dimensional image display device according to an example embodiment of the present disclosure. FIG. 2 is an exploded perspective view schematically illustrating a three-dimensional image display device according to an example embodiment of the present disclosure. FIG. 3 is a cross-sectional view for explaining an optical member of a three-dimensional image display device according to an example embodiment of the present disclosure.

Referring to FIG. 1, a three-dimensional image display device 1000 according to an example embodiment of the present disclosure includes a display panel 100, a gate driver 200, a data driver 300, a timing controller 400 including an image processor 600, a gamma voltage generator 500, and an optical member 700 disposed on the display panel 100. The three-dimensional image display device 1000 according to an example embodiment of the present disclosure can further include a sensor module 800.

Further, referring to FIG. 2, the three-dimensional image display device 1000 can further include a transmissive layer 750 disposed to space apart (e.g., separate) the display panel 100 apart from the optical member 700.

The three-dimensional image display device 1000 can be connected to a host system 2000. The gate driver 200, the data driver 300, the timing controller 400, and the gamma voltage generator 500 can be collectively referred to as a display driver. The gate driver 200 and the data driver 300 can be collectively referred to as a panel driver.

The host system 2000 can be any one of terminal systems such as a computer, a TV system, a set-top box, a tablet, or a mobile phone. The host system 2000 can map a three-dimensional (3D) image signal onto a multi-view map. The multi-view map can be set in various forms depending on the pixel structure of the display panel 100 and the design of the optical member 700. The host system 2000 can provide the mapped multi-view image signal together with timing control signals to the timing controller 400 of the three-dimensional image display device 1000. The timing control signals can include a dot clock, a data enable signal, a vertical sync signal, and a horizontal sync signal.

The sensor module 800 can sense a viewer’s position to obtain viewer position information. The sensor module 800 can obtain the viewer position information by using a camera, an infrared sensor, or the like, and can also obtain a plurality of viewer position information corresponding to different viewing positions. The sensor module 800 can output the obtained viewer position information to at least one of the host system 2000 and the timing controller 400.

The host system 2000 can vary a multi-view map according to the viewer position information supplied from the sensor module 800. The host system 2000 can compare the viewer position information with preset position information of a plurality of viewing zones, and can determine the placement of the multi-view map by varying it in accordance with the viewer position information based on the comparison result. The host system 2000 can map a 3D image signal to the determined multi-view map, output the mapped multi-view image signal, and can output the viewer position information to the timing controller 400.

In the three-dimensional image display device 1000, the display panel 100 can include sub-pixels of multi-view point groups, in which multi-viewpoints are separated on a sub-pixel basis according to the multi-view map. The display panel 100 can display by receiving multi-view image signals for each view with respect to the spatially separated multi-view point groups. Each multi-view point group of the display panel 100 can include a plurality of red sub-pixels R emitting red light, a plurality of green sub-pixels G emitting green light, and a plurality of blue sub-pixels B emitting blue light.

The gate driver 200 can be controlled according to a plurality of gate control signals supplied from the timing controller 400, and can individually drive gate lines of the display panel 100. The gate driver 200 can supply a scan signal of a gate-on voltage to the corresponding gate line during a driving period of each gate line, and can supply a gate-off voltage to the corresponding gate line during a non-driving period of each gate line. The gate driver 200 can be embedded in a bezel region of the display panel 100 in a gate-in-panel (GIP) type, but is not limited thereto. The gate driver 200 embedded in the display panel 100 can receive the plurality of gate control signals from the timing controller 400 through a level shifter. The level shifter can generate the plurality of gate control signals by performing level shifting or logic processing of control signals supplied from the timing controller 400, and can supply the generated gate control signals to the gate driver 200.

The data driver 300 can be controlled according to data control signals supplied from the timing controller 400, and can convert digital data supplied from the timing controller 400 into an analog data signal by using a digital-to-analog conversion circuit. The data driver 300 can subdivide a plurality of reference gamma voltages supplied from the gamma voltage generator 500 into grayscale voltages, and can convert the digital data into the analog data signal by using the subdivided grayscale voltages. The data driver 300 can supply the converted data signal to data lines of the display panel 100.

The data driver 300 can additionally supply a reference voltage to reference lines of the display panel 100 under control of the timing controller 400. The data driver 300 can also supply the reference voltage divided into a display-use voltage and a sensing-use voltage under control of the timing controller 400.

The timing controller 400 can control the gate driver 200 and the data driver 300 by using timing control signals supplied from the host system 2000 and timing setting information stored internally. The timing controller 400 can generate the plurality of gate control signals for controlling driving timings of the gate driver 200, and can supply the same to the gate driver 200. The timing controller 400 can generate the plurality of data control signals for controlling driving timings of the data driver 300, and can supply the same to the data driver 300.

The timing controller 400 can perform various image processing such as image quality compensation, deterioration compensation, and luminance compensation for reducing power consumption with respect to the multi-view image signals supplied from the host system 2000, and can supply the image-processed data to the data driver 300.

The timing controller 400 can include an image processor 600 by itself, but is not limited thereto. For example, the image processor 600 can be configured separately from the timing controller 400 and located at an input end of the timing controller 400, and the image-processed data by the image processor 600 can be output to the data driver 300 through the timing controller 400.

The gamma voltage generator 500 can generate a plurality of reference gamma voltages having different gamma voltage levels and supply them to the data driver 300. The gamma voltage generator 500 can generate the plurality of reference gamma voltages corresponding to gamma characteristics of the three-dimensional image display device 1000 under control of the timing controller 400 and supply them to the data driver 300. The gamma voltage generator 500 can adjust reference gamma voltage levels according to gamma data supplied from the timing controller 400, and can output the adjusted voltages to the data driver 300. The gamma voltage generator 500 can adjust a high potential power supply voltage, which is a maximum gamma voltage, according to peak luminance control supplied from the timing controller 400, and can adjust the plurality of reference gamma voltages according to the adjusted high potential power supply voltage and output the same to the data driver 300.

The optical member 700 can be disposed on a light emitting surface of the display panel 100, for example, on the front surface, and can separate light paths of multi-view images displayed on the display panel 100. Through this, a viewer located in one of a plurality of viewing zones can be provided with a 3D image.

The transmissive layer 750 can be disposed between the display panel 100 and the optical member 700 to space the display panel 100 and the optical member 700 apart by a predetermined distance.

The transmissive layer 750 can secure a gap necessary to collect light of a three-dimensional image emitted from the display panel 100 into both eyes of a viewer, and can be made of, for example, glass or a plastic material having a predetermined thickness and capable of transmitting light, but is not limited thereto. For example, the transmissive layer 750 can be made of a transparent adhesive film such as an optically clear adhesive (OCA) film. In addition, the transmissive layer 750 can have a planar shape corresponding to that of the display panel 100, but is not limited thereto. For example, the transmissive layer 750 can be a kind of diffusion layer that diffuses light emitted from the display panel 100 and can have periodic micro-patterns formed on its surface. FIG. 2 illustrates that the three-dimensional image display device 1000 according to an example embodiment of the present disclosure includes a separate transmissive layer 750 having a predetermined thickness, but the present disclosure is not limited thereto.

Hereinafter, the optical member 700 of the three-dimensional image display device 1000 according to an example embodiment of the present disclosure will be described in detail.

Referring to FIGS. 2 and 3 together, the optical member 700 of the three-dimensional image display device 1000 according to an example embodiment of the present disclosure includes a plurality of color slits 710 that selectively transmit light emitted from the plurality of sub-pixels R, G, and B of the display panel 100, and a plurality of blocking slits 720 that block all light emitted from the plurality of sub-pixels R, G, and B of the display panel 100.

Referring to FIG. 3, the optical member 700 includes a plurality of color slits 710 having a plurality of first color slits 710-1 that transmit light of a first color (e.g., red), a plurality of second color slits 710-2 that transmit light of a second color (e.g., blue), and a plurality of third color slits 710-3 that transmit light of a third color (e.g., green), as well as a plurality of blocking slits 720 that block light emitted from the plurality of sub-pixels SP_R, SP_B, and SP_G of the display panel 100.

As such, the optical member 700 alternately disposes slits that transmit light and slits that block light, and thus separates the light paths of the multi-view image into a plurality of different viewing zones.

The optical member 700 can include a plurality of color slit groups, each including one of the plurality of first color slits 710-1, one of the plurality of second color slits 710-2, and one of the plurality of third color slits 710-3, which are repeatedly disposed in one direction. For example, the plurality of color slits 710 can each be implemented as a color filter that transmits only light of a specific color, but the present disclosure is not limited thereto.

In the optical member 700, a blocking slit 720 is disposed between the plurality of color slit groups. In addition, a blocking slit 720 is disposed between one first color slit 710-1, one second color slit 710-2, and one third color slit 710-3 included in one color slit group of the optical member 700. For example, each of the plurality of blocking slits 720 can be implemented as a black matrix that blocks light of all colors emitted from the plurality of sub-pixels SP_R, SP_B, and SP_G of the display panel 100, but is not limited thereto.

For example, a blocking slit 720, a second color slit 710-2, a blocking slit 720, a third color slit 710-3, and a blocking slit 720 are sequentially disposed in one direction between two first color slits 710-1. A blocking slit 720, a third color slit 710-3, a blocking slit 720, a first color slit 710-1, and a blocking slit 720 are sequentially disposed in one direction between two second color slits 710-2. Further, a blocking slit 720, a first color slit 710-1, a blocking slit 720, a second color slit 710-2, and a blocking slit 720 are sequentially disposed in one direction between two third color slits 710-3. Although FIG. 3 illustrates that the plurality of color slits 710 of the optical member 700 of the three-dimensional image display device 1000 according to an example embodiment of the present disclosure are repeatedly disposed in the order of the first color slit 710-1, the second color slit 710-2, and the third color slit 710-3 in one direction, the placement order of the first color slit 710-1, the second color slit 710-2, and the third color slit 710-3 in the plurality of color slits 710 is not limited thereto. For example, at least one color slit that transmits light of a different color can be disposed between color slits that transmit light of the same color.

Thus, in the optical member 700, between two spaced-apart color slits that transmit light of the same color, two color slits each transmitting light of a color different from the same color can be disposed, and blocking slits 720 can be disposed between the respective color slits.

Meanwhile, a plurality of first sub-pixels SP_R that emits light of a first color (e.g., red), a plurality of second sub-pixels SP_B that emits light of a second color (e.g., blue), and a plurality of third sub-pixels SP_G that emits light of a third color (e.g., green) can be disposed on the display panel 100. Light from each of the plurality of first sub-pixels SP_R, the plurality of second sub-pixels SP_B, and the plurality of third sub-pixels SP_G is transmitted through the plurality of first color slits 710-1, the plurality of second color slits 710-2, and the plurality of third color slits 710-3, respectively. At this time, two or more sub-pixels emitting light of the same color can have their light transmitted through one color slit 710.

In order for a viewer to freely view the multi-view image displayed from the display panel 100 in a plurality of viewing zones, sub-pixels emitting light of a corresponding color must be uniformly distributed with respect to the plurality of first color slits 710-1, the plurality of second color slits 710-2, and the plurality of third color slits 710-3. For example, in the optical member 700, each color slit 710 must be disposed such that the sub-pixels emitting light of the corresponding color are evenly matched with each color slit 710. To achieve this, in the optical member 700, a boundary line located at an equal distance from each of two color slits 710 can be set between the two color slits 710 that transmit light of the same color. At this time, the two color slits 710 that transmit light of the same color are spaced apart from each other, but can be the closest two color slits 710 among the plurality of color slits 710 that transmit light of the same color. The widths of the plurality of color slits 710 and the plurality of blocking slits 720 of the optical member 700 can be set such that the boundary line is positioned so that the same number of sub-pixels, or sub-pixels distributed at a predetermined ratio, are matched to each of the two color slits 710 that transmit light of the same color. Referring to FIG. 3, light emitted from some of the plurality of first sub-pixels SP_R passes through any one first color slit 710-1, and light emitted from the other of the plurality of first sub-pixels SP_R passes through another first color slit 710-1. In this case, based on a first boundary line RL_R that passes through the center between one second color slit 710-2 and one third color slit 710-3 disposed between the two spaced-apart first color slits 710-1, a plurality of first sub-pixels SP_R can be distributed and disposed on both sides. The first boundary line RL_R can pass through the center of the blocking slit 720 between the second color slit 710-2 and the third color slit 710-3. For example, a plurality of first sub-pixels SP_R located between two first boundary lines RL_R set on both sides of one first color slit 710-1 are matched to the corresponding first color slit 710-1.

For example, referring to FIG. 3, a first group R_G1 including six first sub-pixels SP_R can be disposed on the left side of the first boundary line RL_R, and a second group R_G2 including six other first sub-pixels SP_R can be disposed on the right side of the first boundary line RL_R. At this time, light emitted from each of six first sub-pixels SP_R of a first group R_G1 passes through one first color slit 710-1 disposed on the left side with respect to a first boundary line RL_R, and light emitted from each of six first sub-pixels SP_R of a second group R_G2 passes through the other one first color slit 710-1 disposed on the right side with respect to the same first boundary line RL_R. The number of first sub-pixels SP_R included in each of the first group R_G1 and the second group R_G2 disposed on both sides of the first boundary line RL_R can be the same, but is not limited thereto. For example, the number of first sub-pixels SP_R included in each of the first group R_G1 and the second group R_G2 can vary at a predetermined ratio between the plurality of first boundary lines RL_R.

In the same manner, based on a second boundary line RL_B passing through the center between one third color slit 710-3 and one first color slit 710-1 disposed between two spaced-apart second color slits 710-2, a plurality of second sub-pixels SP_B can be distributed and disposed on both sides. The second boundary line RL_B can pass through the center of the blocking slit 720 between the third color slit 710-3 and the first color slit 710-1.

Likewise, based on a third boundary line RL_G passing through the center between one first color slit 710-1 and one second color slit 710-2 disposed between two spaced-apart third color slits 710-3, a plurality of third sub-pixels SP_G can be distributed and disposed on both sides. The third boundary line RL_G can pass through the center of the blocking slit 720 between the first color slit 710-1 and the second color slit 710-2.

For example, the number of first sub-pixels SP_R included in each of the first group R_G1 and the second group R_G2 disposed on both sides of the first boundary line RL_R, the number of second sub-pixels SP_B included in each of the first group and the second group disposed on both sides of the second boundary line RL_B, and the number of third sub-pixels SP_G included in each of the first group and the second group disposed on both sides of the third boundary line RL_G can be the same, but is not limited thereto.

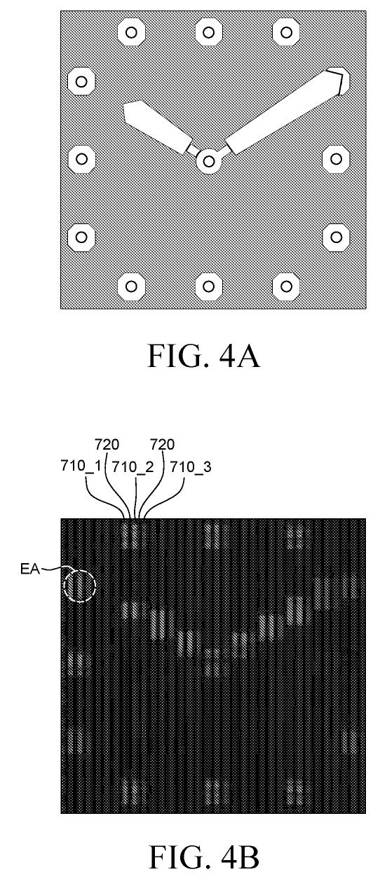

FIG. 4A is an original image to be displayed through the optical member of a three-dimensional image display device according to an example embodiment of the present disclosure. FIG. 4B is an example of a transmitted image displayed through the optical member of a three-dimensional image display device according to an example embodiment of the present disclosure.

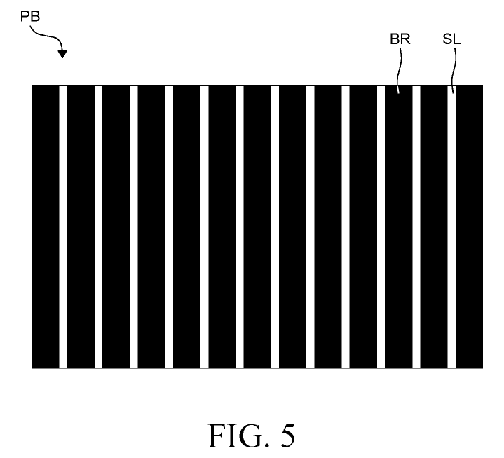

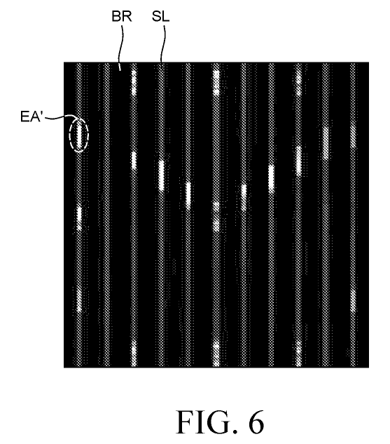

FIG. 5 is a plan view of an optical member according to a comparative embodiment. FIG. 6 is an example of a transmitted image displayed through the optical member according to the comparative embodiment for the original image of FIG. 4A.

The transmitted images illustrated in FIGS. 4B and 6 are examples of images shown to a single eye among a viewer’s two eyes.

In addition, FIGS. 4B and 6 illustrate, as an example, that the pitch of the color slits 710 for each color of the optical member 700 of the three-dimensional image display device 1000 according to an example embodiment of the present disclosure, and the pitch of the opening slits SL of the optical member according to a comparative embodiment, are designed to be the same. In this case, the pitch of the color slits 710 for each color can be the interval between two adjacent color slits 710 transmitting light of the same color, and the pitch of the opening slits SL of the optical member according to the comparative embodiment can be the interval between two adjacent opening slits SL, literally.

For example, in the optical member according to the comparative embodiment illustrated in FIG. 6, the interval between two opening slits SL disposed apart from each other with one barrier BR interposed therebetween can be the same as the interval between two first color slits 710-1 disposed apart from each other in the optical member 700 illustrated in FIG. 4B, with a blocking slit 720, a third color slit 710-3, a blocking slit 720, a second color slit 710-2, and a blocking slit 720 interposed therebetween.

First, referring to FIG. 5, in the optical member according to the comparative embodiment, a plurality of barriers (BR) that block all light emitted from a plurality of sub-pixels of the display panel and opening slits (SL) that transmit all light emitted from a plurality of sub-pixels of the display panel are alternately disposed.

The optical member according to the comparative embodiment can be disposed on the display panel that displays the original image illustrated in FIG. 4A. Light emitted from the plurality of sub-pixels of the display panel corresponding to the original image passes through the opening slits SL of the optical member, and thus the transmitted image illustrated in FIG. 6 is provided to the viewer. For example, the opening slits SL can be empty spaces formed between the plurality of barriers BR or can be areas formed of a transparent material layer.

Meanwhile, light emitted from the plurality of sub-pixels of the display panel 100 corresponding to the original image of FIG. 4A passes through the first color slits 710-1, the second color slits 710-2, and the third color slits 710-3 of the optical member 700, and thus a transmitted image as illustrated in FIG. 4B is provided to the viewer.

Referring to FIGS. 4B and 6 together, it can be confirmed that, for the same area in the original image, the transmitted image portion EA passing through the first color slits 710-1, the second color slits 710-2, and the third color slits 710-3 of the optical member 700 exhibits an improved 3D horizontal resolution by at least three times compared to the transmitted image portion EA′ passing through the opening slits SL of the optical member according to the comparative embodiment.

For example, assuming that the same field of view (FoV) is secured through the optical member 700 of the three-dimensional image display device 1000 according to an example embodiment of the present disclosure and the optical member according to the comparative embodiment, in the case of the optical member 700, it is designed that the pitch of the barriers that block light of a specific color is maintained, while transmission of light of colors other than the specific color within one barrier area is allowed. Accordingly, while implementing the same field of view (FoV) as the optical member according to the comparative embodiment, an effect of increasing the 3D horizontal resolution can be obtained. In this case, the field of view (FoV) can refer to a range of viewing positions at which a viewer can perceive a three-dimensional image when an image displayed on the display panel is displayed as a three-dimensional image through the optical member.

As such, the optical member 700 of the three-dimensional image display device 1000 according to an example embodiment of the present disclosure can improve the 3D horizontal resolution, compared to the structure in which the barriers BR and the opening slits SL are alternately disposed, as in the optical member of the comparative embodiment, when securing the same field of view (FoV).

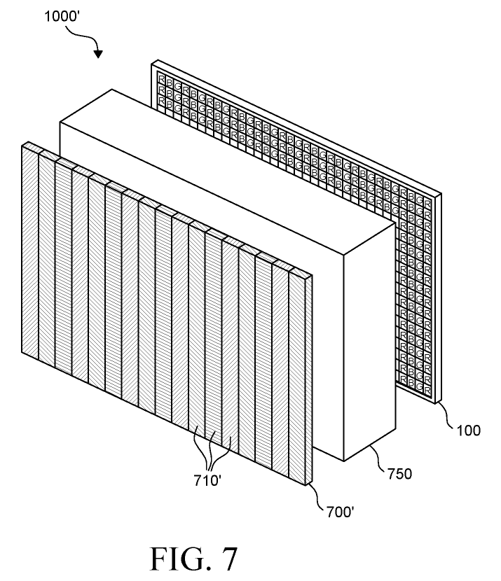

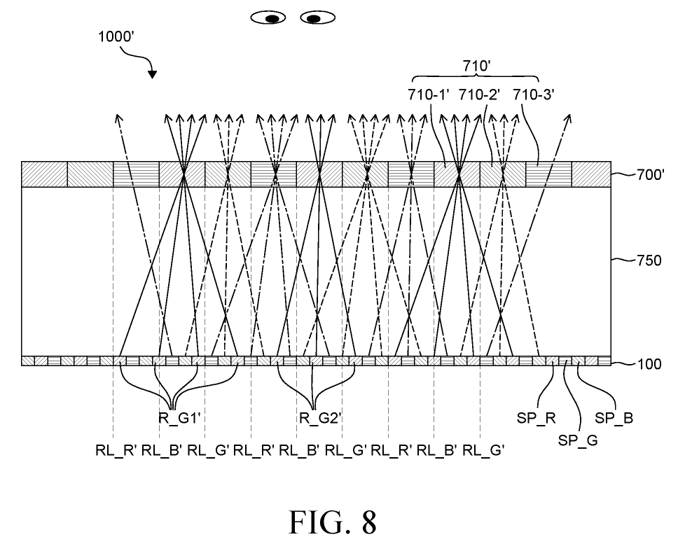

FIG. 7 is an exploded perspective view schematically illustrating a three-dimensional image display device according to another example embodiment of the present disclosure. FIG. 8 is a cross-sectional view for explaining an optical member of a three-dimensional image display device according to another example embodiment of the present disclosure.

Referring to FIGS. 7 and 8, the three-dimensional image display device 1000′ according to another example embodiment of the present disclosure is substantially the same as or similar to the three-dimensional image display device 1000 according to the example embodiment of FIGS. 1 to 4B, except for the structure of the optical member 700′. Therefore, redundant descriptions will be omitted or may be briefly provided. The same reference numerals are used for the same components, and the descriptions thereof can be referred to in FIGS. 1 to 4B.

The three-dimensional image display device 1000′ according to another example embodiment of the present disclosure includes an optical member 700′ having a plurality of color slits 710′ that selectively transmit light emitted from a plurality of sub-pixels (R, G, and B) of the display panel 100. In the optical member 700′, a plurality of color slit groups, each of which includes one of the plurality of first color slits 710-1′, one of the plurality of second color slits 710-2′, and one of the plurality of third color slits 710-3′ can be repeatedly disposed along one direction. For example, each of the plurality of color slits 710′ can be implemented as color filters that transmit only light of a specific color, but the example embodiments of the present disclosure are not limited thereto.

Unlike the optical member 700 of the three-dimensional image display device 1000 according to the aforementioned example embodiment of the present disclosure, the optical member 700′ of the three-dimensional image display device 1000′ according to another example embodiment of the present disclosure includes a plurality of color slits 710′ disposed consecutively in one direction. For example, the optical member 700′ is composed only of the plurality of color slits 710′, and no separate blocking slit is disposed between the plurality of color slits 710′.

The optical member 700′ includes a plurality of color slits 710′ including a plurality of first color slits 710-1′ that transmit light of a first color (e.g., red), a plurality of second color slits 710-2′ that transmit light of a second color (e.g., blue), and a plurality of third color slits 710-3′ that transmit light of a third color (e.g., green).

In the optical member 700′, two color slits that transmit light of different colors are disposed between two spaced-apart color slits that transmit light of the same color. The different colors can be different from the same color.

For example, as shown in FIG. 8, between two first color slits 710-1′, a second color slit 710-2′ and a third color slit 710-3′ are sequentially disposed in one direction. Between two second color slits 710-2′, a third color slit 710-3′ and a first color slit 710-1′ are sequentially disposed along one direction. In addition, between two third color slits 710-3′, a first color slit 710-1′ and a second color slit 710-2′ are sequentially disposed along one direction.

Although FIG. 8 illustrates that the plurality of color slits 710′ of the optical member 700′ are repeatedly disposed in the order of first color slits 710-1′, second color slits 710-2′, and third color slits 710-3′ along one direction, the placement order is not limited thereto. For example, at least one color slit transmitting light of a different color can be disposed between color slits transmitting light of the same color.

On the display panel 100, a plurality of first sub-pixels SP_R emitting light of a first color (e.g., red), a plurality of second sub-pixels SP_B emitting light of a second color (e.g., blue), and a plurality of third sub-pixels SP_G emitting light of a third color (e.g., green) can be disposed. Each of the plurality of first sub-pixels SP_R, the plurality of second sub-pixels SP_B, and the plurality of third sub-pixels SP_G transmits light through one of the plurality of first color slits 710-1′, one of the plurality of second color slits 710-2′, and one of the plurality of third color slits 710-3′. In this case, two or more sub-pixels emitting light of the same color can transmit light through one color slit 710′.

Referring to FIG. 8, light emitted from some of the plurality of first sub-pixels SP_R passes through any one first color slit 710-1′, and light emitted from other ones of the plurality of first sub-pixels SP_R passes through another first color slit 710-1′. At this time, the plurality of first sub-pixels SP_R can be distributed and disposed with respect to a first boundary line RL_R′, which is located between two first color slits 710-1′ that are spaced apart from each other but are closest to each other among the plurality of first color slits 710-1′. For example, between two first color slits 710-1′ that are closest to each other among the plurality of first color slits 710-1′, one second color slit 710-2′ and one third color slit 710-3′ can be disposed, and a plurality of first sub-pixels SP-R can be distributed and disposed on both sides of a first boundary line RL_R′ passing through the center between the second color slit 710-2′ and the third color slit 710-3′. The first boundary line RL_R′ can pass through the center between the second color slit 710-2′ and the third color slit 710-3′, for example, the boundary between the two color slits.

For example, as illustrated in FIG. 8, a first group R_G1′ including three or four first sub-pixels SP_R can be disposed on the left side of the first boundary line RL_R′, and a second group R_G2′ including three or four other first sub-pixels SP_R can be disposed on the right side of the first boundary line RL_R′. At this time, light emitted from each of the first sub-pixels SP_R of the first group R_G1′ can pass through one first color slit 710-1′ located on the left side of the first boundary line RL_R′, and light emitted from each of the first sub-pixels SP_R of the second group R_G2′ can pass through another first color slit 710-1′ located on the right side of the first boundary line RL_R′. As such, the number of first sub-pixels SP_R included in each of a first group R_G1′ and a second group R_G2′ that are disposed on both sides of the first boundary line RL_R′ can be the same or different. For example, the number of first sub-pixels SP_R included in each of the first group R_G1′ and the second group R_G2′ can vary at a predetermined ratio between the plurality of first boundary lines RL_R′.

According to the above-described manner, a plurality of second sub-pixels SP-B can be distributed and disposed on both sides of a second boundary line RL_B′ passing through the center between one third color slit 710-3′ and one first color slit 710-1′ disposed between two spaced-apart second color slits 710-2′. The second boundary line RL_B′ can pass through the center between the third color slit 710-3′ and the first color slit 710-1′, for example, the boundary between the two color slits.

In addition, in the above-described manner, a plurality of third sub-pixels SP-G can be distributed and disposed on both sides of a third boundary line RL_G′ passing through the center between one first color slit 710-1′ and one second color slit 710-2′ disposed between two spaced-apart third color slits 710-3′. The third boundary line RL_G′ can pass through the center between the first color slit 710-1′ and the second color slit 710-2′, for example, the boundary between the two color slits.

The number of first sub-pixels SP-R included in each of a first group R_G1′ and a second group R_G2′ disposed on both sides of the first boundary line RL_R′, the number of second sub-pixels SP-B included in each of a first group and a second group disposed on both sides of the second boundary line RL_B′, and the number of third sub-pixels SP-G included in each of a first group and a second group disposed on both sides of the third boundary line RL_G′ can be the same as each other, but the example embodiments of the present disclosure are not limited thereto.

Compared with the optical member 700 of the three-dimensional image display device 1000 according to an example embodiment of the present disclosure described above, the optical member 700′ of the three-dimensional image display device 1000′ according to another example embodiment of the present disclosure can further increase the 3D horizontal resolution.

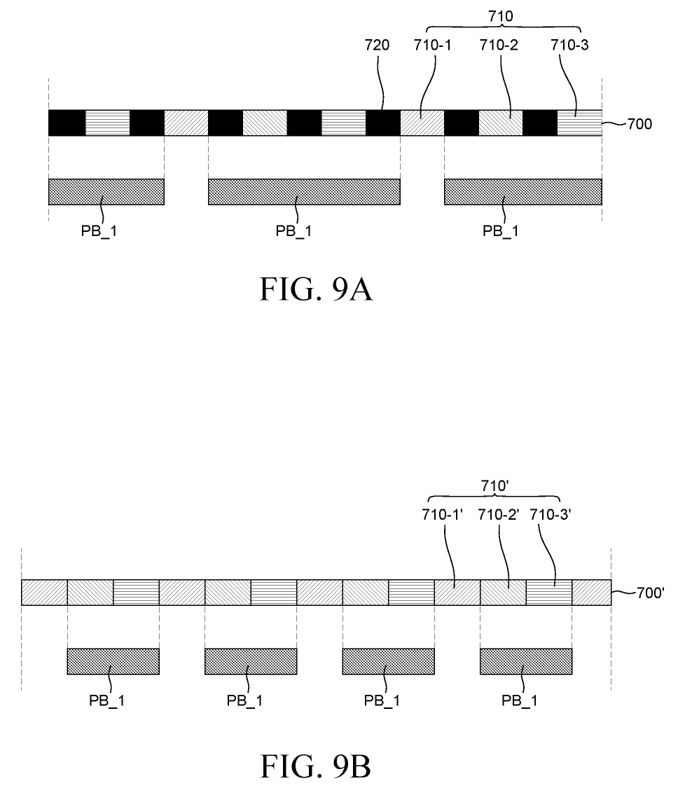

FIG. 9A is a view for explaining an aperture pitch for a single color through the optical member of a three-dimensional image display device according to an example embodiment of the present disclosure. FIG. 9B is a view for explaining an aperture pitch for a single color through the optical member of a three-dimensional image display device according to another example embodiment of the present disclosure.

In FIGS. 9A and 9B, it is illustrated, as an example, that the widths of the plurality of color slits 710 and the color slits 710′ are the same. Although FIGS. 9A and 9B describe the aperture pitch for the first color slit transmitting light of a first color (e.g., red), the aperture pitch for a second color slit and a third color slit, which transmit light of other colors, for example, a second color (e.g., blue) and a third color (e.g., green), respectively, can also be described in the same manner.

Referring to FIG. 9A, in the optical member 700 of the three-dimensional image display device 1000 according to an example embodiment of the present disclosure, blocking slits 720, second color slits 710-2, and third color slits 710-3, which are successively disposed, respectively serve as blocking barriers PB_1 for light of the first color passing through the first color slits 710-1.

Referring to FIG. 9B, in the optical member 700′ of the three-dimensional image display device 1000′ according to another example embodiment of the present disclosure, second color slits 710-2′ and third color slits 710-3′, which are successively disposed, respectively serve as blocking barriers PB_1 for light of the first color passing through the first color slits 710-1′.

Referring to FIGS. 9A and 9B together, the pitch of the first color slits 710-1′ functioning as aperture slits for light of the first color in the optical member 700′ is smaller than the pitch of the first color slits 710-1 functioning as aperture slits for light of the first color in the optical member 700. In addition, the pitch of the blocking barriers PB_1 formed by the second color slits 710-2′ and the third color slits 710-3′ functioning as barriers for light of the first color in the optical member 700′ is smaller than the pitch of the blocking barriers PB_1 formed by the blocking slits 720, the second color slits 710-2, and the third color slits 710-3 functioning as barriers for light of the first color in the optical member 700.

Accordingly, the optical member 700′ may not only significantly improve the 3D horizontal resolution compared to the structure in which the barrier BR and the aperture slit SL are alternately disposed, as in the optical member of the comparative embodiment, but also further improve the 3D horizontal resolution when securing the same field of view (FoV) compared to the structure in which the blocking slit 720 is disposed between the plurality of color slits 710, as in the optical member 700. Furthermore, the optical member 700′ of the three-dimensional image display device 1000′ according to another example embodiment of the present disclosure can secure high-quality 3D horizontal resolution even when the field of view (FoV) is expanded.

The example embodiments of the present disclosure can also be described as follows:

According to an aspect of the present disclosure, there is provided a three-dimensional image display device. The three-dimensional image display device includes a display panel including a plurality of sub-pixels that emit light of different colors. The three-dimensional image display device further includes an optical member including a plurality of color slits for selectively transmitting light emitted from the plurality of sub-pixels. The plurality of color slits transmit the light of different colors.

The plurality of color slits can include a plurality of first color slits for transmitting light of a first color, a plurality of second color slits for transmitting light of a second color, and a plurality of third color slits for transmitting light of a third color. In the optical member, a plurality of color slit groups, each including one of the plurality of first color slits, one of the plurality of second color slits, and one of the plurality of third color slits, can be repeatedly disposed along one direction.

The optical member can further include a plurality of blocking slits for blocking the light emitted from the plurality of sub-pixels. The plurality of blocking slits can be disposed between the plurality of color slit groups.

The plurality of blocking slits can be further disposed between the plurality of color slits.

The one first color slit, the one second color slit and the one third color slit included in the color slit group can be disposed consecutively along the one direction.

Each of the plurality of color slits can be disposed to be evenly matched with sub-pixels of the plurality of sub-pixels emitting light of a color transmitted by the color slit.

According to another aspect of the present disclosure, there is provided a three-dimensional image display device. The three-dimensional image display device includes a display panel including a plurality of first sub-pixels that emit light of a first color, a plurality of second sub-pixels that emit light of a second color, and a plurality of third sub-pixels that emit light of a third color. The three-dimensional image display device further includes an optical member including a plurality of first color slits for transmitting the light of the first color, a plurality of second color slits for transmitting the light of the second color, and a plurality of third color slits for transmitting the light of the third color. The three-dimensional image display device further includes a transmissive layer disposed between the display panel and the optical member to space the display panel apart from the optical member.

In the optical member, one of the second color slits and one of the third color slits can be disposed between two of the first color slits, one of the first color slits and one of the third color slits can be disposed between two of the second color slits, and one of the first color slits and one of the second color slits can be disposed between two of the third color slits.

The optical member can further include a plurality of blocking slits for blocking light emitted from each of the plurality of first sub-pixels, the plurality of second sub-pixels, and the plurality of third sub-pixels.

The plurality of blocking slits can be disposed between the plurality of first color slits, the plurality of second color slits, and the plurality of third color slits.

In the optical member, one of the plurality of first color slits, one of the plurality of second color slits, and one of the plurality of third color slits can be disposed consecutively along one direction.

The optical member can be configured to: transmit light emitted from two or more of the plurality of first sub-pixels through one of the plurality of first color slits; transmit light emitted from two or more of the plurality of second sub-pixels through one of the plurality of second color slits; and transmit light emitted from two or more of the plurality of third sub-pixels through one of the plurality of third color slits.

The optical member can be configured to: transmit light emitted from a first group including two or more of the plurality of first sub-pixels through any one of the two first color slits; and transmit light emitted from a second group including other two or more of the plurality of first sub-pixels through the other one of the two first color slits. The first group can be disposed on one side and the second group can be disposed on the other side based on a boundary line passing through a center between the one second color slit and the one third color slit.

The optical member can be configured to: transmit light emitted from a first group including two or more of the plurality of second sub-pixels through any one of the two second color slits; and transmit light emitted from a second group including other two or more of the plurality of second sub-pixels through the other one of the two second color slits. The first group can be disposed on one side and the second group can be disposed on the other side based on a boundary line passing through a center between the one first color slit and the one third color slit.

The optical member can be configured to: transmit light emitted from a first group including two or more of the plurality of third sub-pixels through any one of the two third color slits; and transmit light emitted from a second group including other two or more of the plurality of third sub-pixels through the other one of the two third color slits. The first group can be disposed on one side and the second group can be disposed on the other side based on a boundary line passing through a center between the one first color slit and the one second color slit.

Although the example embodiments of the present disclosure have been described in detail with reference to the accompanying drawings, the present disclosure is not limited thereto and can be embodied in many different forms without departing from the technical concept of the present disclosure. Therefore, the example embodiments of the present disclosure are provided for illustrative purposes only but not intended to limit the technical concept of the present disclosure. The scope of the technical concept of the present disclosure is not limited thereto. Therefore, it should be understood that the above-described example embodiments are illustrative in all aspects and do not limit the present disclosure.

What is claimed is:

1. A three-dimensional image display device, comprising:
a display panel including a plurality of sub-pixels configured to emit light of different colors; and
an optical member including a plurality of color slits configured to selectively transmit light emitted from the plurality of sub-pixels, so that the plurality of color slits transmit the light of different colors.

2. The three-dimensional image display device of claim 1, wherein the plurality of color slits include a plurality of first color slits for transmitting light of a first color, a plurality of second color slits for transmitting light of a second color, and a plurality of third color slits for transmitting light of a third color, and
a plurality of color slit groups, each including one of the plurality of first color slits, one of the plurality of second color slits, and one of the plurality of third color slits, are repeatedly disposed in the optical member along one direction.

3. The three-dimensional image display device of claim 2, wherein the optical member further includes a plurality of blocking slits for blocking the light emitted from the plurality of sub-pixels, and
the plurality of blocking slits are disposed between the plurality of color slit groups.

4. The three-dimensional image display device of claim 3, wherein the plurality of blocking slits are further disposed between the plurality of color slits.

5. The three-dimensional image display device of claim 2, wherein the one of the plurality of first color slits, the one of the plurality of second color slits and the one of the plurality of third color slits included in each color slit group are disposed consecutively along the one direction.

6. The three-dimensional image display device of claim 1, wherein each of the plurality of color slits is disposed to be evenly matched with sub-pixels of the plurality of sub-pixels emitting light of a specific color transmitted by the color slit.

7. A three-dimensional image display device, comprising:
a display panel including a plurality of first sub-pixels configured to emit light of a first color, a plurality of second sub-pixels configured to emit light of a second color, and a plurality of third sub-pixels configured to emit light of a third color, wherein the first, second and third colors are different from each other;
an optical member including a plurality of first color slits configured to transmit the light of the first color, a plurality of second color slits configured to transmit the light of the second color, and a plurality of third color slits configured to transmit the light of the third color; and
a transmissive layer disposed between the display panel and the optical member to space the display panel apart from the optical member.

8. The three-dimensional image display device of claim 7, wherein in the optical member, one of the plurality of second color slits and one of the plurality of third color slits are disposed between two of the plurality of first color slits, and
one of the plurality of first color slits and one of the plurality of third color slits are disposed between two of the plurality of second color slits.

9. The three-dimensional image display device of claim 8, wherein one of the plurality of first color slits and one of the plurality of second color slits are disposed between two of the plurality of third color slits.

10. The three-dimensional image display device of claim 8, wherein the optical member further includes a plurality of blocking slits configured to block the light emitted from each of the plurality of first sub-pixels, the plurality of second sub-pixels, and the plurality of third sub-pixels.

11. The three-dimensional image display device of claim 10, wherein the plurality of blocking slits are disposed between the plurality of first color slits, the plurality of second color slits, and the plurality of third color slits.

12. The three-dimensional image display device of claim 10, wherein each of the plurality of block slits is disposed between two adjacent sub-pixels among the plurality of first, second and third sub-pixels.

13. The three-dimensional image display device of claim 8, wherein in the optical member, one of the plurality of first color slits, one of the plurality of second color slits, and one of the plurality of third color slits are disposed consecutively along one direction.

14. The three-dimensional image display device of claim 9, wherein the optical member is configured to:
transmit light emitted from two or more of the plurality of first sub-pixels through one of the plurality of first color slits;
transmit light emitted from two or more of the plurality of second sub-pixels through one of the plurality of second color slits; and
transmit light emitted from two or more of the plurality of third sub-pixels through one of the plurality of third color slits.

15. The three-dimensional image display device of claim 9, wherein the optical member is configured to:
transmit light emitted from a first group including two or more of the plurality of first sub-pixels through any one of the two of the plurality of first color slits; and
transmit light emitted from a second group including other two or more of the plurality of first sub-pixels through the other one of the two of the plurality of first color slits,
wherein the first group is disposed on one side and the second group is disposed on the other side based on a boundary line passing through a center between the one of the plurality of second color slits and the one of the plurality of third color slits.

16. The three-dimensional image display device of claim 9, wherein the optical member is configured to:
transmit light emitted from a first group including two or more of the plurality of second sub-pixels through any one of the two of the plurality of second color slits; and
transmit light emitted from a second group including other two or more of the plurality of second sub-pixels through the other one of the two of the plurality of second color slits,
wherein the first group is disposed on one side and the second group is disposed on the other side based on a boundary line passing through a center between the one of the plurality of first color slits and the one of the plurality of third color slits.

17. The three-dimensional image display device of claim 9, wherein the optical member is configured to:
transmit light emitted from a first group including two or more of the plurality of third sub-pixels through any one of the two of the plurality of third color slits; and
transmit light emitted from a second group including other two or more of the plurality of third sub-pixels through the other one of the two of the plurality of third color slits,
wherein the first group is disposed on one side and the second group is disposed on the other side based on a boundary line passing through a center between the one of the plurality of first color slits and the one of the plurality of second color slits.

18. The three-dimensional image display device of claim 7, wherein the plurality of first, second and third color slits are alternatingly disposed in contact with each other.
